(19) United States
(12) Patent Application Publication
(10) Pub. No.: US 2025/0379489 A1
(43) Pub. Date: Dec. 11, 2025

(54) ELECTRIC ACTUATOR

(71) Applicants: Nidec Taiwan Corporation, Taipei City (TW); NIDEC CORPORATION, Kyoto (JP)

(72) Inventors: Huu-Tich NGO, Taipei City (TW); Guo-Jhih YAN, Taipei City (TW)

(21) Appl. No.: 18/836,618

(22) PCT Filed: Feb. 16, 2022
(86) PCT No.: PCT/JP2022/006079

§ 371 Date: Jan. 30, 2025

(51) Int. Cl. H02K 7/102; H01F 7/08; H02K 7/00; H02K 11/21

(52) U.S. Cl. CPC H02K 7/102; H01F 7/081; H02K 7/003; H02K 11/21

(57) ABSTRACT

One aspect of an electric actuator of the present disclosure includes: a motor portion having a rotor rotatable about a motor shaft extending in an axial direction and a stator facing the rotor with a gap interposed therebetween; a reduction gear that decelerates and outputs rotation of the rotor; a brake device that brakes rotation of the rotor; and a position detector that detects a position change of the rotor. The brake device includes: a first brake portion that is a magnetic material disposed on one side in an axial direction of a rotor and is movable in an axial direction between a braking position for braking rotation of the rotor and a non-braking position away from the braking position to one side in the axial direction; a second brake portion that rotates in synchronization with the rotor, is in contact with the first brake portion at the braking position, and is in non-contact with the first brake portion at the non-braking position; and a solenoid that switches the position of the first brake portion between the braking position and the non-braking position according to an energized state. The reduction gear, the brake device, the motor portion and the position detector are sequentially arranged in the axial direction from one side in the axial direction.

### TECHNICAL FIELD

The present disclosure relates to an electric actuator.

### BACKGROUND ART

There is an electric actuator connected to equipment such as a robot arm. In the electric actuator disclosed in Patent Literature 1, a position detector that detects the rotational position of the motor portion and a brake device that stops the rotation of the motor portion in order to ensure the safety of equipment and a system in operation are used.

### PATENT LITERATURE

Patent Literature 1: US Patent No. 09, 579, 805

In the electric actuator described in Patent Literature 1, since the brake device has a pin member that moves in the axial direction of the motor shaft, and a space for accommodating the brake device is separately provided, there is a problem that the dimension in the axial direction is particularly long, leading to an increase in size of the electric actuator. In the electric actuator described in Patent Literature 1, a large impact is generated when the rotation of the motor portion is stopped.

The present invention has been made in consideration of the above points, and an object thereof is to provide a compact electric actuator.

Another object of the present invention is to provide an electric actuator capable of reducing an impact when rotation of a motor portion is stopped.

### SOLUTIONS TO PROBLEMS

One aspect of an electric actuator of the present invention includes: a motor portion that includes a rotor rotatable about a motor shaft extending in an axial direction, and a stator facing the rotor with a gap interposed therebetween; a reduction gear that decelerates and outputs rotation of the rotor; a brake device that brakes rotation of the rotor; and a position detector that detects a position change of the rotor. The brake device includes: a first brake portion that is a magnetic material disposed on one side in the axial direction of the rotor, the first brake portion being movable in the axial direction between a braking position for braking rotation of the rotor and a non-braking position away from the braking position toward the one side in the axial direction; a second brake portion that rotates in synchronization with the rotor, is in contact with the first brake portion at the braking position, and is in non-contact with the first brake portion at the non-braking position; and a solenoid that switches a position of the first brake portion between the braking position and the non-braking position according to an energized state. The reduction gear, the brake device, the motor portion, and the position detector are sequentially arranged in the axial direction from the one side in the axial direction.

According to one aspect of the present invention, a compact electric actuator can be provided.

### BRIEF DESCRIPTION OF DRAWINGS

FIG. 1 is a cross-sectional view illustrating an electric actuator of the present embodiment.

FIG. 2 is an exploded perspective view illustrating a brake device and a cover member of a first embodiment.

FIG. 3 is an enlarged view of an elastic brake portion as viewed in the axial direction.

FIG. 4 is an enlarged cross-sectional view of the periphery of the brake device in which a first brake portion is at a non-braking position.

FIG. 5 is an enlarged cross-sectional view of the periphery of the brake device in which the first brake portion is at a braking position.

FIG. 6 is a partially enlarged view of an elastic brake portion and a tooth portion at a braking position.

FIG. 7 is an exploded perspective view illustrating a brake device and a cover member of a second embodiment.

FIG. 8 is a partially enlarged view of an elastic brake portion according to a third embodiment.

FIG. 9 is a partially enlarged view of an elastic brake portion according to a fourth embodiment.

### DESCRIPTION OF EMBODIMENTS

Hereinafter, an electric actuator according to an embodiment of the present disclosure will be described with reference to the drawings. It is to be noted that the scope of the present disclosure is not limited to the following embodiment, and may be arbitrarily changed within the scope of the technical idea of the present disclosure. Also note that scales, numbers, and the like of members or portions illustrated in the following drawings may differ from those of actual members or portions, for the sake of easier understanding of the members or portions.

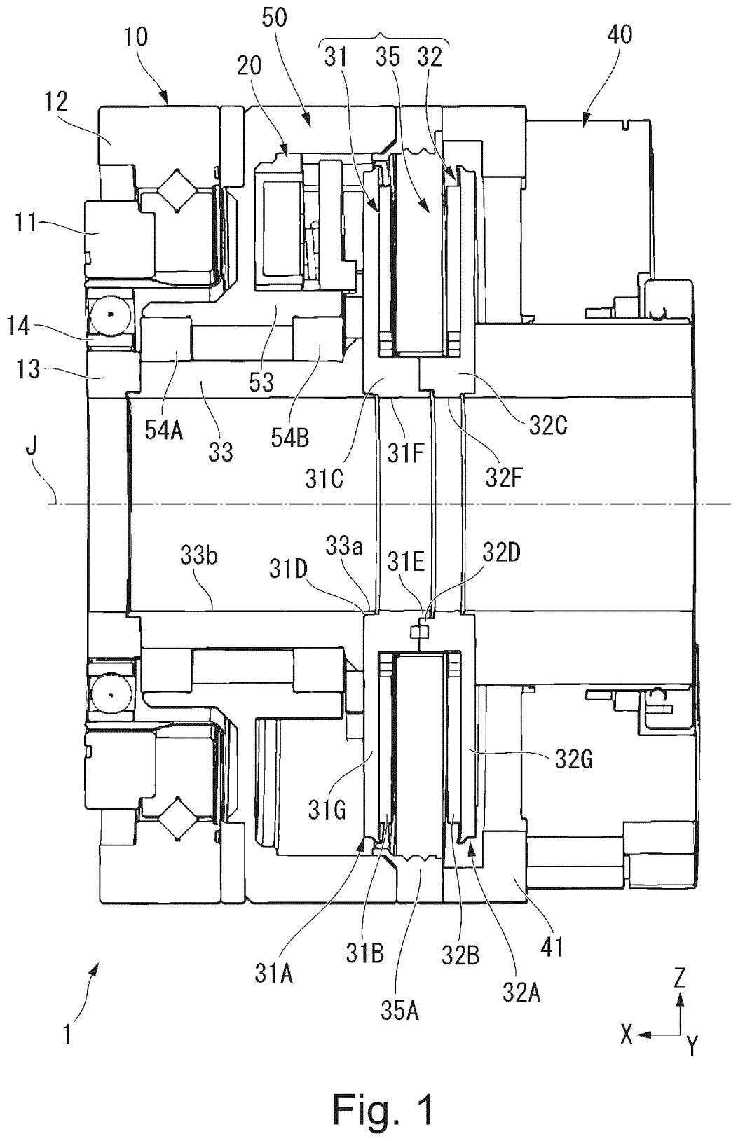

The drawings illustrate an XYZ coordinate system as a three-dimensional orthogonal coordinate system as appropriate. In an XYZ coordinate system, the X-axis direction is a direction parallel to a central axis J illustrated in FIG. 1 and is referred to as an axial direction. The Z-axis direction is a direction orthogonal to the X-axis direction and is an up-down direction in FIG. 1. A Y-axis direction is a direction orthogonal to both the X-axis direction and the Z-axis direction.

In the present specification, the +X side in the X-axis direction, which is one side in the axial direction and the front side of the electric actuator, is referred to as “left side”, and the −X side in the X-axis direction, which is the other side in the axial direction and the rear side of the electric actuator, is referred to as “right side”. The upper side (+Z side) in FIG. 1 in the Z-axis direction is simply referred to as an “upper side”, and the lower side (−Z side) is simply referred to as a “lower side”. Note that the front-rear direction and the up-down direction do not indicate a positional relationship and a direction when incorporated in an actual equipment. In addition, a direction (X-axis direction) parallel to the central axis J may be simply referred to as an “axial direction”, a radial direction centered on the central axis J may be simply referred to as a “radial direction”, and a circumferential direction centered on the central axis J may be simply referred to as a “circumferential direction”.

An electric actuator 1 illustrated in FIG. 1 is, for example, an electric actuator mounted on a vehicle, a robot arm, or the like. As illustrated in FIG. 1, the electric actuator 1 includes a motor portion 30, a reduction gear 10, a brake device 20, a position detector 40, and a cover member 50. The reduction gear 10, the brake device 20, the motor portion 30, and the position detector 40 are sequentially arranged in the axial direction from the left side in the axial direction.

The central axis of the motor portion 30 is the central axis J. The motor portion 30 includes rotors 31 and 32, a stator 35, and a motor shaft 33. The motor shaft 33 has a tubular shape extending around the central axis J. The motor shaft 33 has an annular protrusion 33a and a through hole 33b. The annular protrusion 33a is an annular protrusion protruding to the right side in the axial direction of the motor shaft 33. The annular protrusion 33a is located at the radially inner end of the motor shaft 33. The through hole 33b penetrates the motor shaft 33 in the axial direction.

The rotor 31 is rotatable about the motor shaft 33. The rotor 31 is located on the right side in the axial direction of the motor shaft 33. The rotor 31 includes a rotor core 31A and a rotor magnet 31B. The rotor core 31A has an annular portion 31C and a disk portion 31G. The annular portion 31C has a tubular shape extending around the central axis J. The annular portion 31C has a recess 31D, an annular protrusion 31E, and a through hole 31F. The through hole 31F penetrates the annular portion 31C in the axial direction. The inner diameter of the through hole 31F is the same as the inner diameter of the through hole 33b. The recess 31D is recessed from the left end in the axial direction of the annular portion 31C to the right side in the axial direction. The recess 31D is located at the radially inner end of the annular portion 31C. The recess 31D is fitted to the annular protrusion 33a from the outside in the radial direction. The recess 31D is fitted to the annular protrusion 33a from the outside in the radial direction, whereby the rotor core 31A is positioned with the motor shaft 33 in the radial direction. The disk portion 31G extends radially outward from the outer peripheral surface of the annular portion 31C.

The rotor magnet 31B is provided on the right side in the axial direction of the disk portion 31G in the rotor core 31A. As an example, sixteen rotor magnets 31B are provided at intervals in the circumferential direction.

The rotor 32 is rotatable about the motor shaft 33. The rotor 32 is located on the right side in the axial direction with respect to the rotor 31. The rotor 32 includes a rotor core 32A and a rotor magnet 32B. The rotor core 32A has an annular portion 32C and a disk portion 32G. The annular portion 32C has a tubular shape extending around the central axis J. The annular portion 32C has a recess 32D and a through hole 31F. A through hole 32F penetrates the annular portion 32C in the axial direction. The inner diameter of the through hole 32F is the same as the inner diameters of the through hole 33b and the through hole 31F. The recess 32D is recessed from the right end in the axial direction of the annular portion 32C to the left side in the axial direction. The recess 32D is located at the radially inner end of the annular portion 32C. The recess 32D is fitted to the annular protrusion 31E from the outside in the radial direction. The recess 32D is fitted to the annular protrusion 31E from the outside in the radial direction, whereby the rotor core 32A is positioned in the radial direction with respect to the motor shaft 33 and the rotor core 31A.

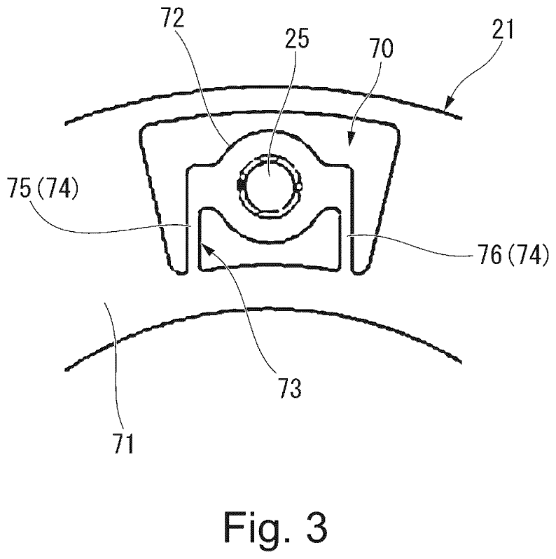

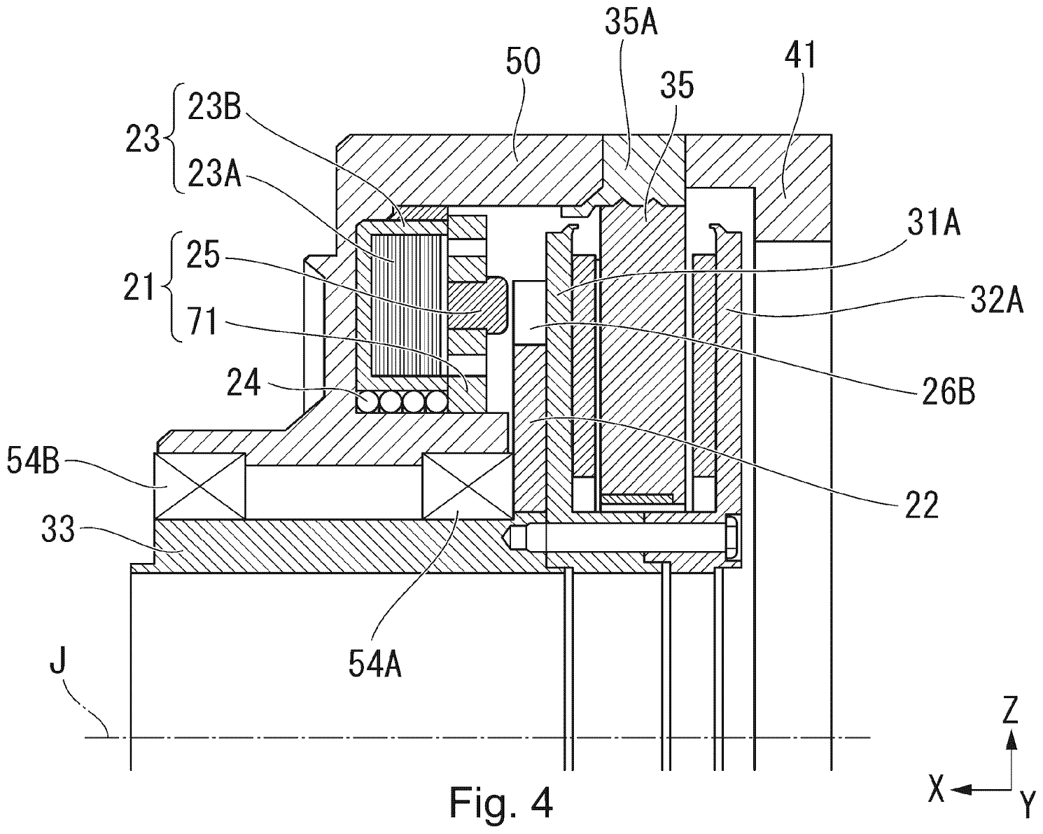

The disk portion 32G extends radially outward from the outer peripheral surface of the annular portion 31C. The rotor core 31A and the rotor core 32A are screwed and fixed to the motor shaft 33 from the right side in the axial direction in the annular portion 31C and the annular portion 32C (see FIGS. 3 and 4). In practice, out of the screwed rotor core 31A and rotor core 32A, the rotor core 31A is screwed to the motor shaft 33, whereby the rotor core 31A and the rotor core 32A are fixed to the motor shaft 33. However, in the following description including the drawings, in order to facilitate understanding, a configuration in which a screw member integrates the rotor core 31A, the rotor core 32A, and the motor shaft 33 will be described. The rotor core 31A, the rotor core 32A, and the motor shaft 33 that are screwed and fixed to the motor shaft 33 in the annular portion 31C and the annular portion 32C rotate integrally.

The rotor magnet 32B is provided on the left side in the axial direction of the disk portion 32G in the rotor core 32A. As an example, sixteen rotor magnets 32B are provided at intervals in the circumferential direction. The rotor magnet 32B is disposed away from the right side in the axial direction of the rotor magnet 31B.

The stator 35 is provided on the radially inner side of a stator cover 35A. The stator cover 35A is fixed to the cover member 50 from the right side in the axial direction. The stator 35 is disposed to face the right side of the rotor magnet 31B in the axial direction of the rotor magnet 31B in the rotor 31 with a gap interposed therebetween. The stator 35 is disposed to face the left side of the rotor magnet 32B in the axial direction of the rotor magnet 32B in the rotor 32 with a gap interposed therebetween. The stator 35 axially faces the rotor magnet 31B in the rotor 31 and the rotor magnet 32B in the rotor 32 with a gap interposed therebetween. That is, the motor portion 30 is an axial flux-type motor (AFM). Since the motor portion 30 is an axial flux-type motor, the motor portion can be made thin and has high torque in the axial direction, and the electric actuator 1 can be downsized in the radial direction.

The reduction gear 10 decelerates and outputs the rotation of the rotors 31 and 32. The reduction gear 10 includes an output flange 11 and an internal 12. The internal 12 is fixed to the cover member 50 from the left side in the axial direction. The output flange 11 is disposed radially inside the internal 12. The output flange 11 is rotatably supported by the motor shaft 33 via a cam ring 13 and a ball bearing 14. The cam ring 13 is screwed and fixed to the motor shaft 33 from the left side in the axial direction. The output flange 11 revolves orbitally with respect to the internal 12 along with the rotation of the motor shaft 33 and rotates at a low speed at the same time, and rotates at a speed lower than that of the motor shaft 33. The output flange 11 transmits the decelerated rotation to the connected equipment.

The position detector 40 detects a position change of the rotor 32. The position detector 40 is fixed to the right side in the axial direction of the cover member 50 via the stator cover 35A and an adapter 41.

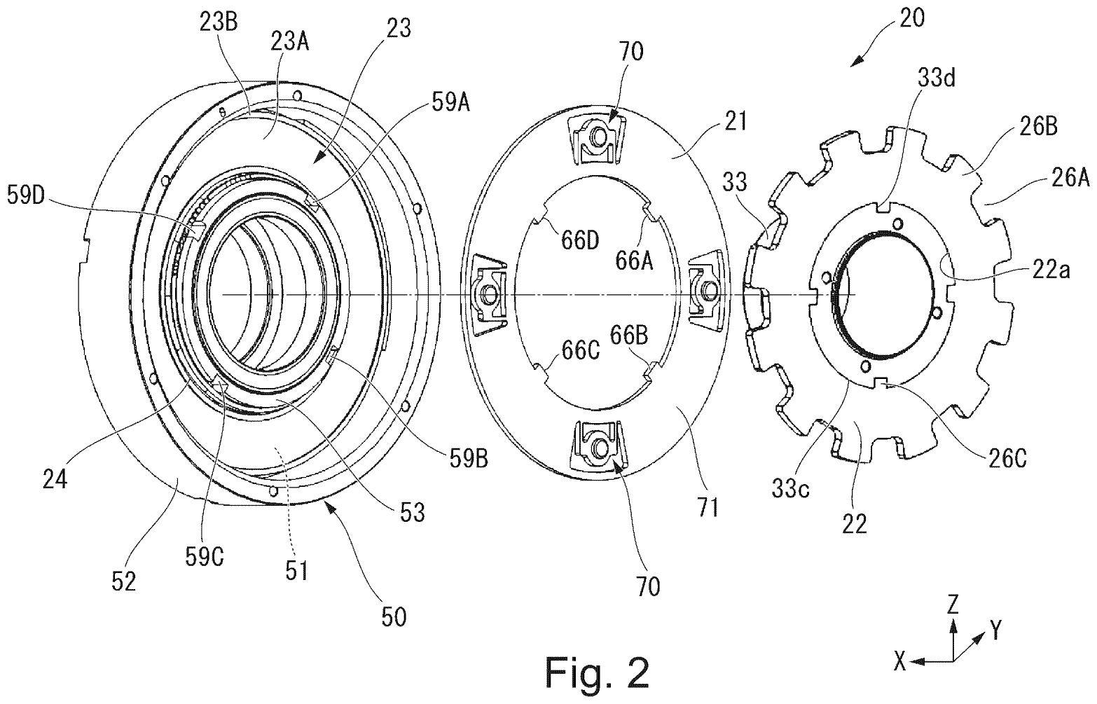

The cover member 50 is located on the left side in the axial direction of the motor portion 30. The cover member 50 accommodates the motor portion 30 therein. As illustrated in FIG. 2, the cover member 50 includes a peripheral wall portion 51, an outer peripheral wall 52, and an inner peripheral wall 53. The peripheral wall portion 51 has an annular shape that is orthogonal to the axial direction and extends in the circumferential direction around the axial direction. The outer peripheral wall 52 has a tubular shape extending from the outer edge of the peripheral wall portion 51 to the right side in the axial direction over the entire circumference. The inner peripheral wall 53 has a tubular shape extending from the inner edge of the peripheral wall portion 51 to the right side in the axial direction over the entire circumference. The cover member 50 accommodates the motor portion 30 in a space surrounded by the peripheral wall portion 51, the outer peripheral wall 52, and the inner peripheral wall 53. As illustrated in FIG. 1, the cover member 50 is supported by the motor shaft 33 via ball bearings 54A and 54B fitted to the inner peripheral wall 53.

The inner peripheral wall 53 of the cover member 50 has guide groove portions 59A, 59B, 59C, and 59D. Each of the guide groove portions 59A, 59B, 59C, and 59D is recessed radially inward from the outer peripheral surface of the inner peripheral wall 53. Each of the guide groove portions 59A, 59B, 59C, and 59D extends in the axial direction and opens on the right end surface of the inner peripheral wall 53 in the axial direction. The guide groove portions 59A, 59B, 59C, and 59D are arranged at intervals of 90° in the circumferential direction.

### [First Embodiment of Brake Device]

The brake device 20 brakes the rotation of the rotors 31 and 32. As illustrated in FIG. 2, the brake device 20 according to the first embodiment includes a first brake portion 21, a second brake portion 22, a solenoid 23, and an elastic member 24. The brake device 20 is accommodated inside the cover member 50. The first brake portion 21, the second brake portion 22, the solenoid 23, and the elastic member 24 are accommodated inside the cover member 50.

Since the brake device 20 is accommodated inside the cover member 50 in which the motor portion 30 is accommodated, it is not necessary to separately provide a space for accommodating the brake device 20. Therefore, the electric actuator 1 can be downsized by suppressing an increase in size particularly due to an increase in axial dimension.

The first brake portion 21 is annularly provided over the entire circumference. The first brake portion 21 is a magnetic material. The first brake portion 21 includes an elastic brake portion 70, a frame 71, and protrusions 66A, 66B, 66C, and 66D.

The frame 71 has an annular shape extending in the circumferential direction. The outer diameter of the outer peripheral surface of the frame 71 is smaller than the inner diameter of the outer peripheral wall 52. The inner diameter of the inner peripheral surface of the frame 71 is larger than the outer diameter of the inner peripheral wall 53. The protrusions 66A, 66B, 66C, and 66D protrude radially inward from the inner peripheral surface of the frame 71. The protrusions 66A, 66B, 66C, and 66D are arranged at intervals of 90° in the circumferential direction. The protrusions 66A, 66B, 66C, and 66D are fitted to the guide groove portions 59A, 59B, 59C, and 59D, respectively, from the right side in the axial direction. The frame 71 in which the protrusions 66A, 66B, 66C, and 66D are fitted to the guide groove portions 59A, 59B, 59C, and 59D, respectively, is guided by the guide groove portions 59A, 59B, 59C, and 59D to be movable in the axial direction in the state of being circumferentially positioned by the cover member 50.

The elastic brake portion 70 elastically moves in the circumferential direction to brake the second brake portion 22. Four elastic brake portions 70 are arranged at intervals of 90° in the circumferential direction. As illustrated in FIG. 3, the elastic brake portion 70 includes a projecting portion 25, a holder 72, and an elastic portion 73. The projecting portion 25 protrudes to the right side in the axial direction from the frame 71. The projecting portion 25 is located at the center of the frame 71 in the radial direction. The projecting portion 25 has a circular shape when viewed in the axial direction. As an example, the projecting portion 25 is a pin press-fitted to the frame 71.

The holder 72 has a disk shape that surrounds and holds the projecting portion 25. The elastic portion 73 connects the holder 72 and the frame 71. The elastic portion 73 elastically deforms in the circumferential direction to relatively move the holder 72 in the circumferential direction with respect to the frame 71. The elastic portion 73 includes a rib 74 extending in a direction intersecting the circumferential direction. The rib 74 includes a first rib 75 and a second rib 76. The first rib 75 and the second rib 76 extend in the radial direction. The first rib 75 connects one side in the circumferential direction of the holder 72 and the frame 71. The radially outer side of the first rib 75 is connected to the one side in the circumferential direction of the holder 72, and the radially inner side is connected to the frame 71. The second rib 76 connects the other side in the circumferential direction of the holder 72 and the frame 71. The radially outer side of the second rib 76 is connected to the one side in the circumferential direction of the holder 72, and the radially inner side is connected to the frame 71. The holder 72, the first rib 75, and the second rib 76 are located on the same plane as the frame 71. The holder 72, the first rib 75, and the second rib 76 can be manufactured by, for example, punching the periphery of the holder 72, the first rib 75, and the second rib 76 with respect to the annular frame 71 by press working or the like.

When the frame 71 moves to the right side in the axial direction and the projecting portion 25 is located on the rotation path of the second brake portion 22, the rotation of the second brake portion 22 is braked and stopped as the rotating second brake portion 22 comes into contact with the projecting portion 25 from one side in the circumferential direction. The load on the other side in the circumferential direction when the second brake portion 22 comes into contact with the projecting portion 25 is transmitted to the first rib 75 and the second rib 76 via the holder 72. The first rib 75 and the second rib 76 are elastically deformed to the other side in the circumferential direction by the transmitted load. When the first rib 75 and the second rib 76 are elastically deformed to the other side in the circumferential direction, the projecting portion 25 and the holder 72 move to the other side in the circumferential direction. A part of kinetic energy of the rotating second brake portion 22 is consumed for elastic deformation of the first rib 75 and the second rib 76 and movement of the projecting portion 25 and the holder 72 when the second brake portion 22 comes into contact with the projecting portion 25. Therefore, the impact when the rotating second brake portion 22 comes into contact with the projecting portion 25 is reduced by the elastic deformation of the first rib 75 and the second rib 76 and the movement of the projecting portion 25 and the holder 72.

The elastic member 24 is a coil spring. The elastic member 24 is a compression spring. The elastic member 24 is located on the left side in the axial direction of the first brake portion 21. The elastic member 24 is inserted into the inner peripheral wall 53. The elastic member 24 is annularly disposed on the radially outer side of the inner peripheral wall 53 about the central axis J. The left end portion in the axial direction of the elastic member 24 is in contact with the peripheral wall portion 51 from the right side in the axial direction. The right end portion in the axial direction of the elastic member 24 is in contact with the first brake portion 21 from the left side in the axial direction. The elastic member 24 whose left end portion in the axial direction is in contact with the peripheral wall portion 51 pushes the first brake portion 21 to the right in the axial direction by the elastic restoring force. Since the elastic member 24 is annularly disposed, the first brake portion 21 can be stably pushed to the right side in the axial direction in a balanced state without being biased in the circumferential direction.

As illustrated in FIGS. 3 and 4, the solenoid 23 includes a coil 23A and a case 23B. The cross-sectional shape of the case 23B is a U shape that opens to the right side. The case 23B is disposed in an annular shape over the entire circumference along the peripheral wall portion 51. The coil 23A is wound and accommodated in the case 23B in the circumferential direction. As an example, the case 23B is fixed to the right surface in the axial direction of the peripheral wall portion 51 using an epoxy adhesive. The solenoid 23 is disposed to face the first brake portion 21 in the axial direction. The first brake portion 21 is disposed to face the right side in the axial direction of the solenoid 23.

The solenoid 23 pulls the first brake portion 21, which is a magnetic material disposed to face the first brake portion, to the left side in the axial direction against the force that the elastic member 24 pushes due to the elastic restoring force by the electromagnetic force generated when the coil 23A is energized. In the solenoid 23, when the energization to the coil 23A is stopped and the energization is not performed, the electromagnetic force for pulling the first brake portion 21 is lost. As the electromagnetic force by the solenoid 23 is lost, the first brake portion 21 is pushed to the right side in the axial direction by the elastic restoring force of the elastic member 24. Therefore, the solenoid 23 can switch the position of the first brake portion 21 between a non-braking position to be described later pulled to the left side in the axial direction by the electromagnetic force and a braking position pushed to the right side in the axial direction by the elastic restoring force of the elastic member 24 according to the energized state.

The second brake portion 22 rotates in synchronization with the rotors 31 and 32. As illustrated in FIG. 2, the second brake portion 22 includes a tooth portion 26B and a protrusion 26C. The tooth portion 26B is disposed on the outer periphery, which is the radially outer end portion of the second brake portion 22, with a plurality of (twelve in FIG. 2) gaps 26A interposed therebetween. That is, in the second brake portion 22, the gap 26A and the tooth portion 26B are alternately arranged on the outer periphery over the entire circumference. The radial positions of the gap 26A and the tooth portion 26B are positions overlapping with the projecting portion 25.

The protrusion 26C protrudes radially inward from an inner peripheral surface 22a of the second brake portion 22. A plurality of (four in FIG. 2) protrusions 26C are arranged at intervals in the circumferential direction. The inner peripheral surface 22a of the second brake portion 22 is fitted to an outer peripheral surface 33c of the right end portion in the axial direction of the motor shaft 33. The motor shaft 33 has a recess 33d recessed radially inward from the outer peripheral surface 33c. A plurality of (four in FIG. 2) recesses 33d are arranged at intervals in the circumferential direction. The protrusion 26C of the second brake portion 22 is fitted to the recess 33d of the motor shaft 33. The second brake portion 22 in which the protrusion 26C is fitted to the recess 33d is positioned in the circumferential direction with respect to the motor shaft 33. The second brake portion 22 is fixed in close contact with the left side of the rotor core 31A in the axial direction. The second brake portion 22 positioned in the circumferential direction with respect to the motor shaft 33 and fixed to the rotor core 31A rotates integrally in synchronization with the rotor core 31A, the rotor core 32A, and the motor shaft 33.

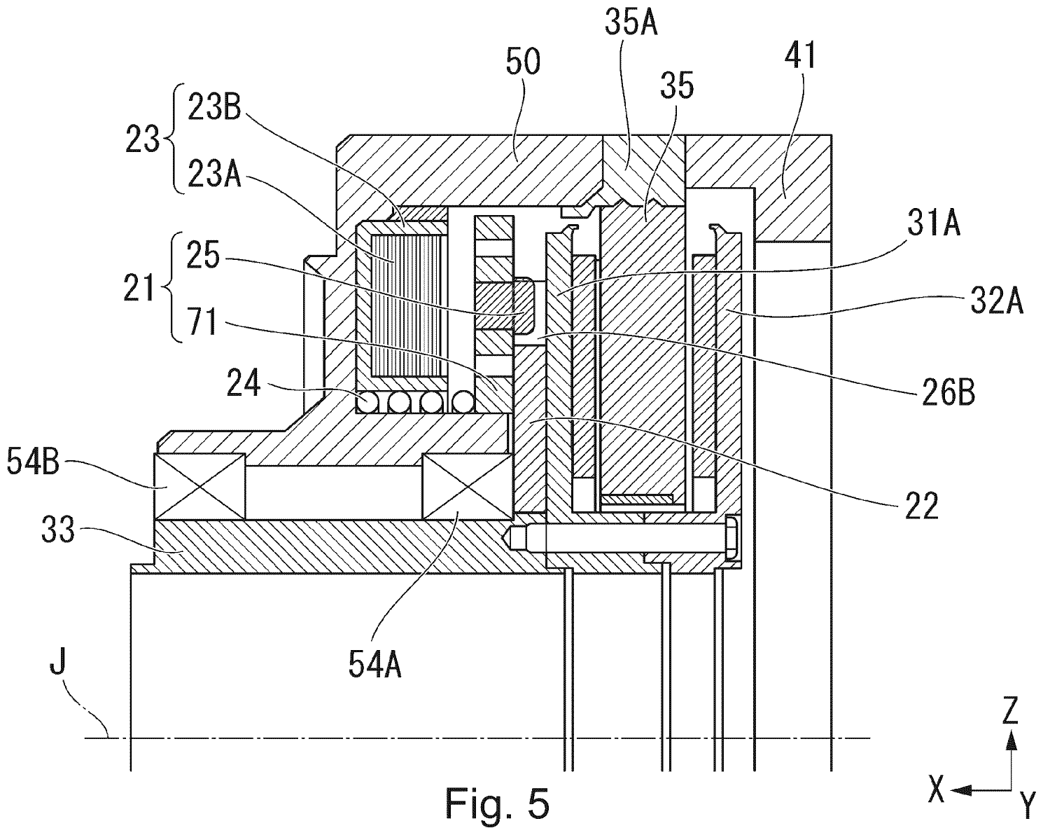

The position of the first brake portion 21 in the axial direction when the electromagnetic force by the solenoid 23 is lost and pushed by the elastic restoring force of the elastic member 24 is a braking position where the projecting portion 25 overlaps with the gap 26A or the tooth portion 26B to brake the rotation of the rotor 31 as illustrated in FIG. 5. Specifically, the position of the first brake portion 21 in the axial direction when the electromagnetic force by the solenoid 23 is lost and the first brake portion 21 is pushed by the elastic restoring force of the elastic member 24 is the braking position where the projecting portion 25 is located on the rotation path of the tooth portion 26B.

As illustrated in FIG. 4, the position of the first brake portion 21 in the axial direction when pulled by the electromagnetic force of the solenoid 23 is a non-braking position where the projecting portion 25 is separated to the left side from the braking position. The first brake portion 21 is movable in the axial direction between the braking position and the non-braking position. That is, the second brake portion 22 comes into contact with the first brake portion 21 at the braking position and does not come into contact with the first brake portion 21 at the non-braking position.

Therefore, while power is supplied, the first brake portion 21 is at the non-braking position in a non-contact manner with the second brake portion 22 by the electromagnetic force of the solenoid 23, and the rotation of the rotors 31 and 32 can transmit the decelerated rotation to the equipment connected to the output flange 11. On the other hand, when the supply of power is stopped, the electromagnetic force by the solenoid 23 is lost, so that the first brake portion 21 is pushed and moved to the right side in the axial direction by the elastic restoring force of the elastic member 24, and is switched to the braking position in contact with the second brake portion 22.

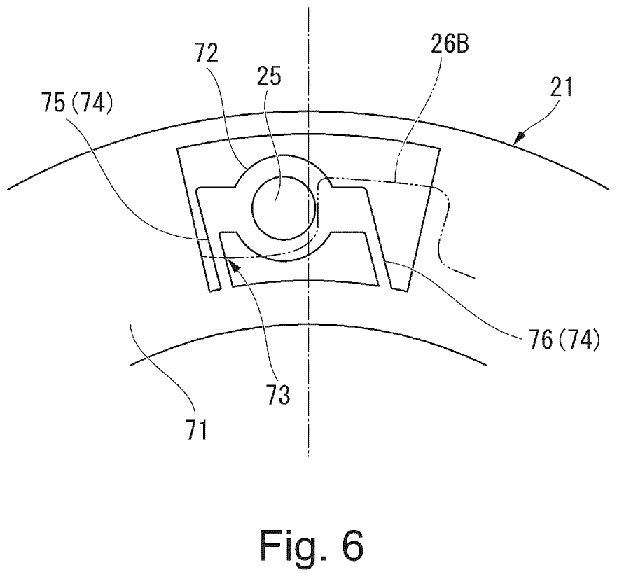

As illustrated in FIG. 6, in the first brake portion 21 at the braking position, since the projecting portion 25 is located on the rotation path of the tooth portion 26B, the tooth portion 26B interferes with the projecting portion 25. As a result, the first rib 75 and the second rib 76 are elastically deformed to the other side in the circumferential direction, and after the projecting portion 25 and the holder 72 move to the other side in the circumferential direction, the rotations of the rotors 31 and 32 are braked and stopped. As a result, rotation transmission to the equipment connected to the output flange 11 can be stopped.

As described above, in the electric actuator 1 of the present embodiment, since the reduction gear 10, the brake device 20, the motor portion 30, and the position detector 40 are sequentially arranged along the axial direction, it is possible to suppress an increase in size of the device as in a case where the brake device 20 is disposed at the position of the position detector 40.

In the electric actuator 1 of the present embodiment, when the first brake portion 21 brakes the rotation of the second brake portion 22 in the brake device 20, the first rib 75 and the second rib 76 are elastically deformed to the other side in the circumferential direction, and the projecting portion 25 and the holder 72 move to the other side in the circumferential direction. Therefore, in the electric actuator 1 of the present embodiment, the impact when the rotating second brake portion 22 comes into contact with the projecting portion 25 is reduced by the elastic deformation of the first rib 75 and the second rib 76 and the movement of the projecting portion 25 and the holder 72, and can be suitably applied to an electric actuator having a large torque.

In the electric actuator 1 of the present embodiment, since the first brake portion 21 moves in the axial direction by being guided by the guide groove portions 59A, 59B, 59C, and 59D provided in the cover member 50, it is not necessary to separately provide a guide member, and further downsizing and cost reduction can be realized.

### [Second Embodiment of Brake Device]

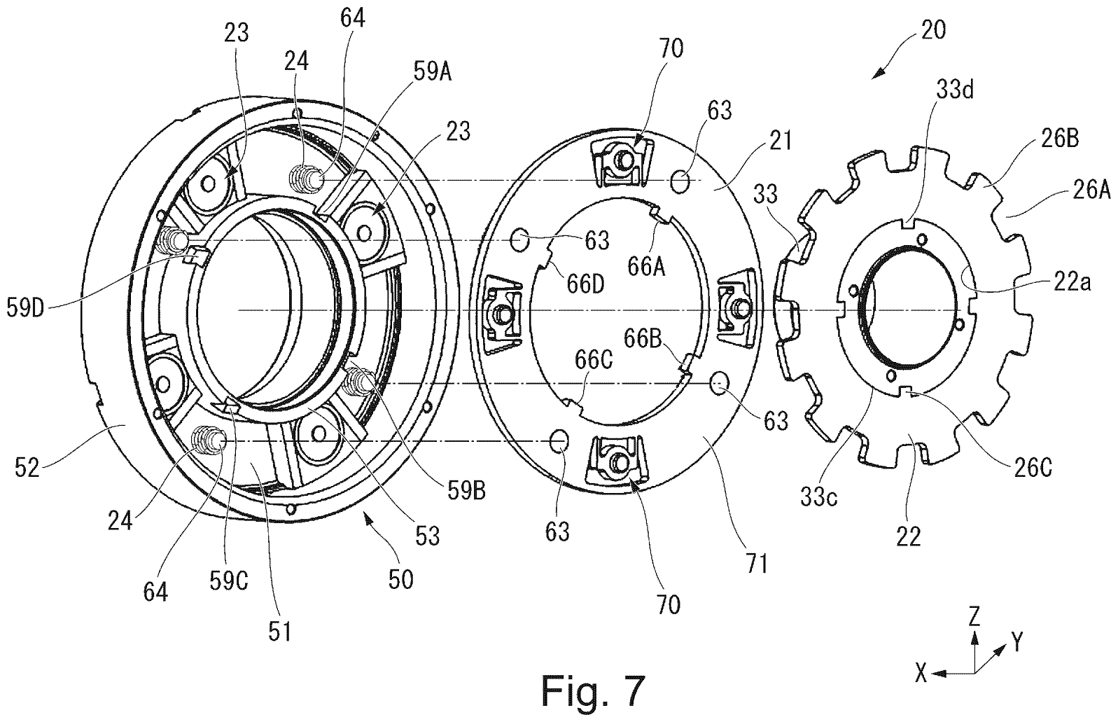

A second embodiment of the brake device 20 will be described with reference to FIG. 7.

In the drawing, the same elements as those of the first embodiment illustrated in FIGS. 1 to 6 are denoted by the same reference numerals, and the description thereof will be omitted.

As illustrated in FIG. 7, a plurality of solenoids 23 in the electric actuator 1 of the present embodiment are arranged at positions facing the first brake portion 21 at intervals in the circumferential direction. Four solenoids 23 are provided at intervals of 90° in the circumferential direction. The circumferential position of the solenoid 23 is the center position between the elastic brake portions 70 adjacent to each other in the circumferential direction in the first brake portion 21.

Four elastic members 24 are arranged between the solenoid 23 and the elastic brake portion 70 in the circumferential direction. The elastic members 24 are the elastic members 24 are provided at intervals of 90° in the circumferential direction. The elastic member 24 is inserted into the shaft 64. The shaft 64 is arranged to extend in an axial direction. The shaft 64 is fixed by press-fitting the distal end on the right side in the axial direction into a hole provided in the first brake portion 21. In the shaft 64 in which the right distal end is press-fitted to the hole 63, the left side in the axial direction protrudes from the first brake portion 21 to the left side in the axial direction and extends. In addition to the configuration in which the shaft 64 is press-fitted to the first brake portion 21, the shaft may be provided in the first brake portion 21 by shaving.

Other configurations are the same as those of the first embodiment.

In the electric actuator 1 having the above configuration, while power is supplied, the first brake portion 21 is held at the non-braking position by the electromagnetic force of the four solenoids 23. On the other hand, when the supply of power is stopped, the electromagnetic force by the four solenoids 23 is lost, so that the first brake portion 21 is pushed and moved to the right side in the axial direction by the elastic restoring force of the four elastic members 24 and is switched to the braking position. In the first brake portion 21 at the braking position, since the projecting portion 25 is located in the gap 26A on the rotation path of the tooth portion 26B, the tooth portion 26B interferes with the projecting portion 25, so that the rotation of the rotors 31 and 32 is braked and stopped. As a result, the rotation transmission to the equipment connected to the output flange 11 can be stopped.

In the electric actuator 1 of the present embodiment, in addition to obtaining the same operation and effect as those of the first embodiment, the plurality of small solenoids 23 are used so that further miniaturization can be realized.

### [Third Embodiment of Brake Device]

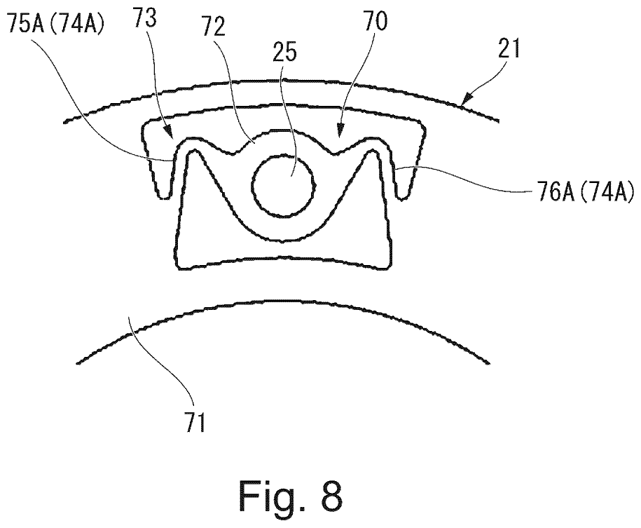

A third embodiment of the brake device 20 will be described with reference to FIG. 8.

In the drawing, the same elements as those of the first embodiment illustrated in FIGS. 1 to 6 are denoted by the same reference numerals, and the description thereof will be omitted.

As illustrated in FIG. 8, the elastic brake portion 70 in the electric actuator 1 of the present embodiment includes a rib 74A as the elastic portion 73. The rib 74A includes a first rib 75A and a second rib 76A. The first rib 75A is folded back in an arc shape at a distal end extending in a direction toward the outside in the radial direction from the holder 72 toward one side in the circumferential direction, extends in a direction toward the inside in the radial direction, and is connected to the frame 71. The second rib 76A is folded back in an arc shape at a distal end extending in a direction toward the outside in the radial direction from the holder 72 toward the other side in the circumferential direction, extends in a direction toward the inside in the radial direction, and is connected to the frame 71.

Other configurations are the same as those of the first embodiment.

In the electric actuator 1 of the present embodiment, in addition to obtaining the same operation and effect as those of the first embodiment, the number of deformation portions when elastically deformed by the load at the time of braking increases, so that the bending resistance at the time of elastic deformation increases. Therefore, in the electric actuator 1 of the present embodiment, the energy consumed for bending of the first rib 75A and the second rib 76A in the kinetic energy of the rotating second brake portion 22 becomes larger, and the impact at the time of braking can be further reduced.

### [Fourth Embodiment of Brake Device]

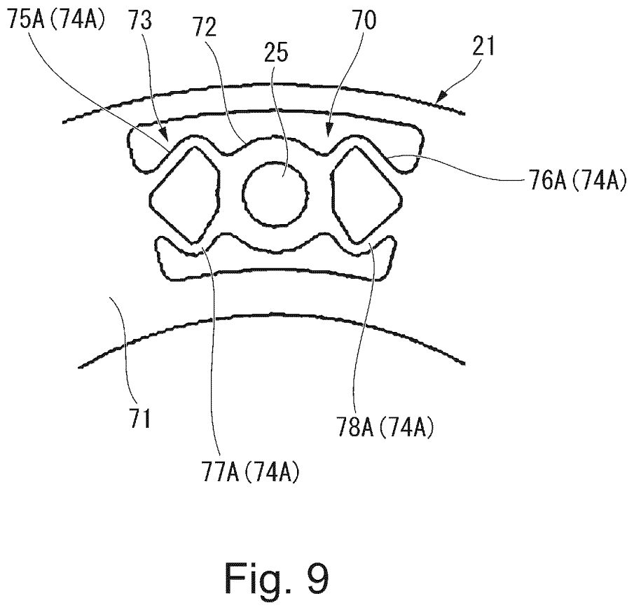

A fourth embodiment of the brake device 20 will be described with reference to FIG. 9.

In the drawing, the same elements as those of the third embodiment illustrated in FIG. 8 are denoted by the same reference numerals, and the description thereof will be omitted.

As illustrated in FIG. 9, the elastic brake portion 70 in the electric actuator 1 of the present embodiment includes a rib 74A as the elastic portion 73. The rib 74A includes a third rib 77A and a fourth rib 78A in addition to the first rib 75A and the second rib 76A described above.

The third rib 77A is folded back in an arc shape at a distal end extending in a direction toward the inside in the radial direction from a position on the inner side in the radial direction of the first rib 75A in the holder 72 toward one side in the circumferential direction, extends in a direction toward the outside in the radial direction, and is connected to the frame 71. The fourth rib 78A is folded back in an arc shape at a distal end extending in a direction toward the inside in the radial direction from a position on the inner side in the radial direction of the second rib 76A in the holder 72 toward the other side in the circumferential direction, extends in a direction toward the outside in the radial direction, and is connected to the frame 71.

Other configurations are the same as those of the third embodiment.

In the electric actuator 1 of the present embodiment, in addition to obtaining the same operation and effect as those of the third embodiment, the number of deformation portions when elastically deformed by the load at the time of braking further increases, so that the bending resistance at the time of elastic deformation increases more. Therefore, in the electric actuator 1 of the present embodiment, the energy consumed for bending of the first rib 75A, the second rib 76A, the third rib 77A, and the fourth rib 78A among the kinetic energy of the rotating second brake portion 22 is further increased, and the impact at the time of braking can be further reduced.

While the preferred embodiments of the present invention have been described above with reference to the accompanying drawings, it is obvious that the present invention is not limited to the embodiments. Various shapes, combinations, and the like of the constituent members in the above embodiments are only by way of example, and various modifications are possible based on design requirements and the like without departing from the gist of the present invention.

For example, in the above embodiment, the configuration in which the rotors 31 and 32 and the stator 35 in the motor portion 30 are axial gap motors facing each other with a gap interposed therebetween in the axial direction has been exemplified, but the present invention is not limited to this configuration. The motor portion 30 may be a radial gap motor in which the rotor and the stator face each other in the radial direction with a gap interposed therebetween.

In a case where the motor portion 30 is a radial gap motor, the second brake portion may be provided at a position facing the first brake portion in the axial direction in the rotor.

In the above embodiment, the configuration in which the second brake portion 22 is provided in close contact with the rotor 31 has been exemplified, but the present invention is not limited to this configuration. For example, a cylindrical bush member may be provided in a whirl-stop structure at a position axially away from the rotor 31 in the motor shaft 33, and a second brake portion extending radially outward from the bush member may be provided.

In addition, the shape of the projecting portion 25 of the first brake portion 21 exemplified in the above embodiment is an example, and other shapes may be used as long as the rotation of the second brake portion 22 can be braked.

### REFERENCE SIGNS LIST

1 electric actuator
10 reduction gear
20 brake device
21 first brake portion
22 second brake part
23 solenoid
23A coil
23B case
24 elastic member
25 protrusion
26A void
26B tooth portion
30 motor portion
31, 32 rotor
33 motor shaft
35 stator
40 position detector
50 cover member
51 peripheral wall portion
52 outer peripheral wall
53 inner peripheral wall
71 frame
72 holder
73 elastic part
74, 74A rib
75, 75A first rib
76, 76A second rib

1. An electric actuator comprising:
a motor portion that includes a rotor rotatable about a motor shaft extending in an axial direction, and a stator facing the rotor with a gap interposed therebetween;
a reduction gear that decelerates and outputs rotation of the rotor;
a brake device that brakes rotation of the rotor; and
a position detector that detects a position change of the rotor,
wherein the brake device includes:
a first brake portion that is a magnetic material disposed on one side in the axial direction of the rotor, the first brake portion being movable in the axial direction between a braking position for braking rotation of the rotor and a non-braking position away from the braking position toward the one side in the axial direction;
a second brake portion that rotates in synchronization with the rotor, is in contact with the first brake portion at the braking position, and is in non-contact with the first brake portion at the non-braking position; and
a solenoid that switches a position of the first brake portion between the braking position and the non-braking position according to an energized state, and
the reduction gear, the brake device, the motor portion, and the position detector are sequentially arranged in the axial direction from the one side in the axial direction.

2. The electric actuator according to claim 1, wherein
the first brake portion includes:
a frame movable in the axial direction;
a projecting portion protruding to another side in the axial direction with respect to the frame;
a holder that holds the projecting portion; and
an elastic portion connecting the holder and the frame, and
the holder is movable in a circumferential direction by elastic deformation of the elastic portion.

3. The electric actuator according to claim 2, wherein the elastic portion includes a rib extending in a direction intersecting a circumferential direction.

4. The electric actuator according to claim 3, wherein
the rib includes:
a first rib extending in a radial direction and connecting one side in a circumferential direction of the holder and the frame; and
a second rib extending in a radial direction and connecting another side in the circumferential direction of the holder and the frame.

5. The electric actuator according to claim 3, wherein
the rib includes:
a first rib that is folded back at a distal end extending in a direction toward one side in a radial direction from the holder toward one side in a circumferential direction, extends in a direction toward another side in the radial direction, and is connected to the frame; and
a second rib that is folded back at a distal end extending in a direction toward one side in a radial direction from the holder toward another side in a circumferential direction, extends in a direction toward another side in the radial direction, and is connected to the frame.

6. The electric actuator according to claim 5, comprising:
a third rib that is folded back at a distal end extending in a direction toward another side in a radial direction from a position on another side in the radial direction with respect to the first rib in the holder toward one side in a circumferential direction, extends in a direction toward one side in the radial direction, and is connected to the frame; and
a fourth rib that is folded back at a distal end extending in a direction toward another side in a radial direction from a position on another side in the radial direction with respect to the second rib in the holder toward another side in a circumferential direction, extends in a direction toward one side in the radial direction, and is connected to the frame.

7. The electric actuator according to any one of claims 2 to 6, wherein the second brake portion is fixed to the motor shaft at a position separated from the rotor in the axial direction.

8. The electric actuator according to any one of claims 2 to 7, wherein
the frame has an annular shape extending in a circumferential direction,
a plurality of the projecting portions, the holders, and the elastic portions are arranged at intervals in a circumferential direction, and
a plurality of the solenoids are arranged at positions facing the frame at intervals in a circumferential direction.

9. The electric actuator according to any one of claims 2 to 7, wherein
the frame has an annular shape extending in a circumferential direction,
a plurality of the projecting portions, the holders, and the elastic portions are arranged at intervals in a circumferential direction,
the solenoid includes a coil wound in a circumferential direction and a case accommodating the coil, and
the coil and the case are annularly arranged over an entire circumference at positions facing the first brake portion in the axial direction.

10. The electric actuator according to any one of claims 1 to 9, wherein the rotor and the stator face each other in the axial direction with a gap interposed therebetween.
